(19) United States
(12) Patent Application Publication
(10) Pub. No.: US 2026/0161725 A1
(43) Pub. Date: Jun. 11, 2026

(54) FUZZY CONTENT-BASED WEB RESOURCE COLLAPSING TECHNIQUES

(71) Applicant: Cycognito, Ltd., Tel Aviv (IL)

(72) Inventors: Dima POTEKHIN, Tel Aviv (IL); Rob N GURZEEV, Palo Alto, CA (US)

(73) Assignee: Cycognito, Ltd., Tel Aviv (IL)

(21) Appl. No.: 18/974,085

(22) Filed: Dec. 9, 2024

(51) Int. Cl. G06F 16/958; G06F 16/951

(52) U.S. Cl. CPC G06F 16/958; G06F 16/951

(57) ABSTRACT

A system and method for generating a compact digital representation of a web content is presented. The method includes detecting a first web-based resource, including a first plurality of content components; detecting a second web-based resource, including a second plurality of content components; generating a representation of the first-web based resource; associating the second web-based resource with the representation of the first web-based resource in response to detecting a match between at least a content of the first plurality of content components and at least a content of the second plurality of content components; and generating a representation of the second web-based resource, in response to detecting no match between the first plurality of content components and the second plurality of content components.

### TECHNICAL FIELD

The present disclosure relates generally to securing digital assets, and specifically to determining external attack surface components using a compact representation.

### BACKGROUND

External Attack Surface Management (EASM) involves identifying, analyzing, and monitoring all digital assets exposed to the public internet to understand and mitigate potential security risks. These assets form an organization's external attack surface, which includes anything from websites, IP addresses, cloud services, APIs, third-party integrations, and other publicly accessible digital points. The attack surface can be extensive, especially for large organizations or those relying on diverse cloud environments, third-party platforms, and web applications, as each component adds a new point of potential vulnerability.

An organization's attack surface can span across thousands of assets, with each publicly exposed element creating an entry point for potential attackers. A single misconfigured server or overlooked subdomain can introduce significant risks, as attackers continuously scan for such weaknesses to exploit. Compounding the complexity, the attack surface is in constant flux, with new services or applications being deployed regularly, adding to the challenge of maintaining a clear and up-to-date understanding of all exposed assets.

One key problem with external attack surfaces is the difficulty of fully understanding and controlling them. Shadow IT, i.e., systems or services created without explicit organizational approval, can also expand the attack surface without detection, making it challenging to ensure all exposed assets are adequately secured. This lack of comprehensive visibility increases the likelihood of misconfigurations, forgotten assets, and other vulnerabilities, leaving organizations vulnerable to breaches, data leaks, and other cybersecurity threats.

It is further complicated when multiple assets share entry points (e.g., multiple servers sharing an IP address), or assets are duplicated across a computing environment, multiple computing environments, etc.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include detecting a first web-based resource, including a first plurality of content components. The method may also include detecting a second web-based resource, including a second plurality of content components. The method may furthermore include generating a representation of the first-web based resource. The method may in addition include associating the second web-based resource with the representation of the first web-based resource in response to detecting a match between at least a content of the first plurality of content components and at least a content of the second plurality of content components. The method may moreover include generating a representation of the second web-based resource, in response to detecting no match between the first plurality of content components and the second plurality of content components. Other embodiments of this aspect include corresponding computer systems, apparatus, and computer programs recorded on one or more computer storage devices, each configured to perform the actions of the methods.

Implementations may include one or more of the following features. The method may include: detecting that the first web-based resource and the second web-based resource share any one of: a domain, a sub-domain, an IP address, and a combination thereof. The method may include: discovering a plurality of workloads through a public network; associating a portion of the workloads of the plurality of workloads with an organization; and detecting the first web-based resource and the second web-based resource on any workload of the portion of the workloads. The method may include: applying a detection rule to detect the match, where the detection rule includes a fuzzy logic condition. The method may include: determining a probability value that the first web-based resource is similar to the second web-based resource; and associating the representation of the second web-based resource with the representation of the first web-based resource in response to determining that the probability value exceeds a threshold. The method may include: generating the representation of the second-web based resource in response to determining that the probability value is below the threshold. The method may include: configuring a generative artificial intelligence (AI) model to detect a match between a first content component of the first plurality of content components and a second content component of the second plurality of content components. The method where the generative AI includes any one of: a language model, a generative transformer model, a generative adversarial model, a convolutional neural network, and any combination thereof. The method may include: updating a representation with associated web-based resources, in response to determining that a content component of an associated web-based resource has changed. Implementations of the described techniques may include hardware, a method or process, or a computer tangible medium.

In one general aspect, non-transitory computer-readable medium may include one or more instructions that, when executed by one or more processors of a device, cause the device to: detect a first web-based resource, including a first plurality of content components; detect a second web-based resource, including a second plurality of content components; generate a representation of the first-web based resource; associate the second web-based resource with the representation of the first web-based resource in response to detecting a match between at least a content of the first plurality of content components and at least a content of the second plurality of content components; and generate a representation of the second web-based resource, in response to detecting no match between the first plurality of content components and the second plurality of content components. Other embodiments of this aspect include corresponding computer systems, apparatus, and computer programs recorded on one or more computer storage devices, each configured to perform the actions of the methods.

In one general aspect, a system may include one or more processors configured to:. The system may also detect a first web-based resource, including a first plurality of content components. The system may furthermore detect a second web-based resource, including a second plurality of content components. The system may in addition generate a representation of the first-web based resource. The system may moreover associate the second web-based resource with the representation of the first web-based resource in response to detecting a match between at least a content of the first plurality of content components and at least a content of the second plurality of content components. The system may also generate a representation of the second web-based resource, in response to detecting no match between the first plurality of content components and the second plurality of content components. Other embodiments of this aspect include corresponding computer systems, apparatus, and computer programs recorded on one or more computer storage devices, each configured to perform the actions of the methods.

Implementations may include one or more of the following features. The system where the one or more processors are further configured to: detect that the first web-based resource and the second web-based resource share any one of: a domain, a sub-domain, an IP address, and a combination thereof. The system where the one or more processors are further configured to: discover a plurality of workloads through a public network; associate a portion of the workloads of the plurality of workloads with an organization; and detect the first web-based resource and the second web-based resource on any workload of the portion of the workloads. The system where the one or more processors are further configured to: apply a detection rule to detect the match, where the detection rule includes a fuzzy logic condition. The system where the one or more processors are further configured to: determine a probability value that the first web-based resource is similar to the second web-based resource; and associate the representation of the second web-based resource with the representation of the first web-based resource in response to determining that the probability value exceeds a threshold. The system where the one or more processors are further configured to: generate the representation of the second-web based resource in response to determining that the probability value is below the threshold. The system where the one or more processors are further configured to: configure a generative artificial intelligence (AI) model to detect a match between a first content component of the first plurality of content components and a second content component of the second plurality of content components. The system where the generative AI includes any one of: a language model, a generative transformer model, a generative adversarial model, a convolutional neural network, and any combination thereof. The system where the one or more processors are further configured to: update a representation with associated web-based resources, in response to determining that a content component of an associated web-based resource has changed. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a computing environment having persistent digital assets discovered by an external attack surface detector, utilized to describe an embodiment.

FIG. 2 is an example schematic diagram of a network having a resolution server for collapsing content, implemented in accordance with an embodiment.

FIG. 3 is an example flowchart of a method for collapsing content in a digital representation, implemented in accordance with an embodiment.

FIG. 4 is an example schematic diagram of a resolution server according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

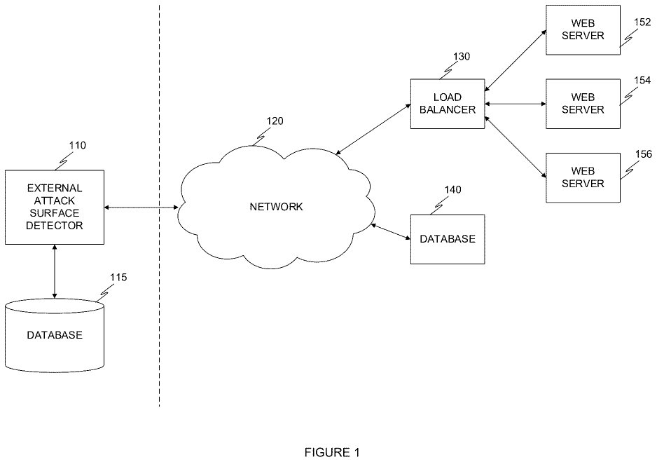

FIG. 1 is a network diagram of a computing environment having persistent digital assets discovered by an external attack surface detector, utilized to describe an embodiment. A network computing environment, according to an embodiment, includes virtual digital assets, physical digital assets, combinations thereof, and the like. In an embodiment, a virtual digital asset is a virtual machine, a software container, a serverless function, a virtual appliance, an application image, a web server, a load balancer, a database, a distributed storage service, a combination thereof, and the like.

In some embodiments, a physical digital asset is a bare metal machine, a server rack, a processor, a memory, a storage, combinations thereof, and the like.

In an embodiment, a computing environment includes a load balancer 130, which exposes web servers, such as a first web server 152, a second web server 154, and a third web server 156. In some embodiments, the computing environment includes a database 140. In certain embodiments, the computing environment, elements thereof, and the like, are connected to a network 120.

In some embodiments, the network 120 includes, but is not limited to, a wireless, cellular or wired network, a local area network (LAN), a wide area network (WAN), a metro area network (MAN), the Internet, the worldwide web (WWW), similar networks, and any combination thereof.

According to an embodiment, a computing environment includes an external attack surface. An external attack surface includes, in an embodiment, machines, devices, digital assets, physical assets, and the like, which are exposed through a network 120, an external network (i.e., a network which is external to a network of the computing environment), a public network, combinations thereof, and the like.

For example, in an embodiment, a load balancer 130 is part of a computing environment's external attack surface, as the load balancer 130 is exposed to a network which includes network elements that are not part of the computing environment. For example, a load balancer 130 that is exposed to the Internet is part of an attack surface, according to an embodiment. Gaining access through an external attack surface is a common way attackers gain access to network computing environments. It is therefore advantageous to detect an organization's external attack surface, so that cybersecurity measures can be put in place, including deterring attackers, remediate attacks, mitigate attacks, and the like.

In certain embodiments, an external attack surface detector 110 is configured to detect a computing environment's external attack surface. In some embodiments, a computing environment is a cloud computing environment, a networked computing environment, a hybrid computing environment, a combination thereof, and the like.

In some embodiments, a cloud computing environment is a virtual private cloud (VPC), a virtual network (VNet), and the like. In certain embodiments, a cloud computing environment is deployed on a cloud computing infrastructure, such as Amazon® Web Services (AWS), Google® Cloud Platform (GCP), Microsoft® Azure®, and the like.

In an embodiment, an external attack surface detector 110 is configured to detect the computing environment's external attack surface, based on an identifier of an organization. For example, according to an embodiment, a detector 110 is configured to detect a domain name service (DNS) record based on the organization identifier. In an embodiment, a DNS record is detected by querying a DNS server with the organization identifier. An organization identifier is, for example, a legal entity name, a subsidiary name, a tax ID number, a company ID number, a combination thereof, and the like.

In certain embodiments, a DNS query returns a response including a plurality of network addresses. For example, according to an embodiment, a DNS query response includes a static IP address, a dynamic IP address, a combination thereof, and the like.

In an embodiment, a network protocol message is generated based on a network address detected in the DNS query response. For example, in an embodiment, a network protocol message includes generating a PING command to an IP address, a range of IP addresses, and the like, and receive a response to the network protocol message.

In certain embodiments, the network protocol is TCP/IP, UDP, HTTP, SSH, a combination thereof, and the like. In some embodiments, the network protocol message is delivered over a unique port, a plurality of unique ports, and the like. For example, in an embodiment, an HTTP message is generated, and the same message is transmitted over port 80 and port 8080 to the same IP address.

According to an embodiment, a reply is received in response to sending the network protocol message. For example, in an embodiment, an HTTP response includes a code, such as 404, 503, etc. In certain embodiments, a detector 110 is configured to generate a representation of a digital asset based on a predefined data schema, and store such a representation in a database 115. For example, in an embodiment, the detector 110 is configured to generate a representation of a digital asset based on digital asset information.

In an embodiment, digital asset information includes a network address, a network address range, a domain identifier, a sub-domain name, a namespace identifier, a MAC address, an operating system identifier, an application version, an application identifier, a certificate, a hash of a certificate, a checksum result, a web application, an HTML code, a combination thereof, and the like.

In an embodiment, the detector 110 is configured to extract a value from digital asset information, and store the extracted value in a representation of the digital asset, for example in the database 115. Digital assets are often not static across time, which presents a challenge in identifying persistent digital assets. As a simple example, a digital asset has a first IP address at a first time, and a second IP address at a second time. This can occur, for example, due to a change in a static IP of a domain. In an embodiment, such a change is detected based on a DNS record.

In certain embodiments, the detector 110 is configured to detect when digital asset information applies to an existing digital asset (e.g., a change of IP address), or when digital asset information applies to a new digital asset. In some embodiments the detector 110 is configured to apply a policy, a rule, a conditional rule, a heuristic, a combination thereof, and the like, to determine if digital asset information is applied to a new digital asset or a previously detected digital asset.

In some embodiments, a digital asset representation includes a plurality of attributes, each attribute having a corresponding value. For example, in an embodiment, the detector 110 is configured to detect, extract, and the like, a value from digital asset information, and store such an extracted value in the digital asset representation of the digital asset.

In some embodiments, the detector is configured to determine if a digital asset information applies to a new digital asset or a previously detected digital asset based on a threshold. For example, in an embodiment, an attribute includes a threshold, a change threshold, and the like. In certain embodiments, where an attribute value changes at a frequency which exceeds the threshold, the digital asset information is determined to be of a new digital asset.

In certain embodiments, the threshold is applied to a number of attributes changing together. For example, where digital asset information includes the same IP address with a different port, for the same protocol, the detector 110 is configured to determine that the digital asset is the previously detected digital asset (i.e., only one attribute changed). In an embodiment, where the digital asset information includes a different IP address, a different port, and the same protocol, the detector 110 is configured to determine that the digital asset information applies to a new digital asset.

In some embodiments, certain changes are disregarded in determining if the digital asset is a previously detected digital asset or not. For example, where a DNS record indicates that a domain changed an IP address, then each digital asset associated with the domain has likely changed IP address as well, and therefore the digital asset information pertaining to that digital asset is determined based on other factors, attributes, and the like, which are not the IP address.

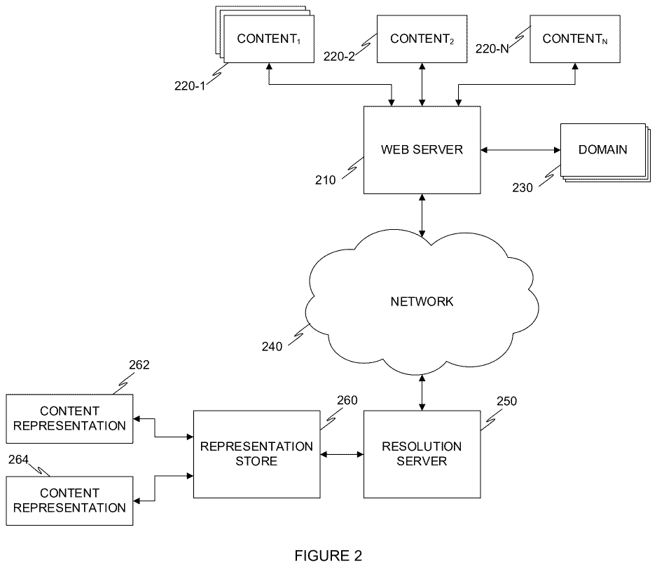

FIG. 2 is an example schematic diagram of a network having a resolution server for collapsing content, implemented in accordance with an embodiment. In an embodiment, a web server 120 is configured to provide web-based resources. According to an embodiment, a web-based resource is a content, such as contents 220-1 through 220-N, referred to collectively as contents 220, and individually as content 220, where ‘N’ is an integer having a value of ‘2’ or greater.

In an embodiment, a content 220 is provided as a web-based resource. For example, a web page (e.g., HTML document) is a content which is provided as a web-based resource. In some embodiments, content 220 is utilized to generate content which is then provided as a web-based resource. For example, in an embodiment, a first content 220-1 includes a plurality of images, a second content 220-2 includes a text, etc. A web server 120 is configured, according to an embodiment, to provide a web-based resource for example by generating the web-based resource based on a style sheet language, such as cascading style sheets (CSS).

In some embodiments, the web server 210 is associated with a domain 230, a plurality of domains, an IP address, a plurality of IP addresses, and the like. For example, the web server 210 includes a plurality of content servers, a proxy server, a load balancer, a gateway, a combination thereof, and the like. In an embodiment, the web server 210 is the web server 152, web server 154, web server 156, a combination thereof, etc., of FIG. 1 above.

In certain embodiments, the web server 210, elements thereof, and the like, are connected to a network 240. In some embodiments, the network 240 includes, but is not limited to, a wireless, cellular or wired network, a local area network (LAN), a wide area network (WAN), a metro area network (MAN), the Internet, the worldwide web (WWW), similar networks, and any combination thereof. In an embodiment, the network 240 is, is connected to, is part of, is included in, etc., the network 120 of FIG. 1 above.

In an embodiment, the network 120 providers further connectivity for a resolution server 250. According to an embodiment, the resolution server 250 is configured to generate a representation of content from the web server 210. In an embodiment, generated representation are stored in a representation store 260.

It is advantageous, in some embodiments, to determine content which is stored, provided, etc., from a web server 210. For example, web servers can be compared to determine similarity, redundancy, etc., based on content stored thereon. However, content which is the “same” to a human is not necessarily what a machine defines as “same”. The latter is often a rigid definition, for example two files are considered the same when a checksum result performed on the files returns the same result.

For content, a picture can have multiple resolutions, however for the purpose of a human viewing the content, multiple pictures of the same object, each having a different resolution, can be considered the same. Therefore content servers, web servers 210 serving content, etc., can be considered the same for certain purposes, certain functionalities, etc., based on the contents stored therein, provided therefrom, etc.

For example, according to an embodiment, a first content representation 262 represents content 220-1, and a second content representation 264 represents content 220-2 and content 220-N, in response to determining that content 220-2 and content 220-N are the same. In an embodiment, determining that a content is the same is performed by a resolution server 250 configured to so perform.

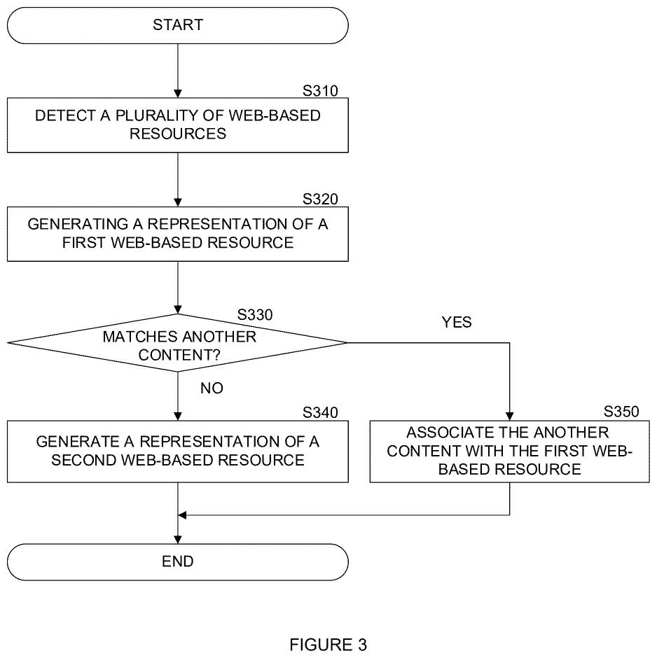

FIG. 3 is an example flowchart of a method for collapsing content in a digital representation, implemented in accordance with an embodiment. According to an embodiment, it is advantageous to collapse a plurality of content items into a single representation for example for applying controls, detections, etc. In some embodiments, collapsing content allows for rapidly comparing content servers to determine if two servers include the same content, provide the same functionality, etc.

At S310, a plurality of web-based resources are detected. In an embodiment, a web-based resource includes a uniform resource locator (URL), uniform resource identifier (URI), and the like. In some embodiments, a web-based resource includes a plurality of contents, content elements, etc. For example, in an embodiment, a web-based resource is a hypertext markup language (HTML) document, a stylesheet, a multimedia, a video, a picture, a script, a combination thereof, and the like.

In an embodiment, a web-based resource is a web page, a file transfer site, a message board, and the like. In an embodiment, the web-based resource includes a transfer protocol (FTP, HTTP, HTTPS, etc.), a port (e.g., 80, 8080, etc.), a parameter, a combination thereof, and the like.

In an embodiment, detecting a resource is performed by network discovery, web crawling, web scraping, and the like. In some embodiments, an external attack surface detector is utilized in detecting only web-based resources which are associated with a single organization.

At S320, a representation is generated. in an embodiment, the representation is a digital representation of a first web-based resource of the plurality of web-based resources. In some embodiments, the representation is stored in a database, such as a column-oriented database, a graph database, a combination thereof, and the like.

In an embodiment, the representation includes metadata of the web-based resource. In some embodiments, the representation includes an identifier of the web-based resource. In some embodiments, a representation is generated for each content element of the web-based resource.

In certain embodiments, a representation of a content element is connected to the representation of the web-based resource. In an embodiment, certain content elements are not utilized in generating the representation. For example, content elements which are associated with advertisements are not utilized in generating the representation, according to an embodiment. Determining that content should not be represented can occur, for example, by determining a URL from which the content is fetched (e.g., ads.google.com) and deploying a rule to exclude such a domain from content representations.

According to an embodiment, a representation is stored in a representation store. In some embodiments, the representation store is configured to periodically evict representations from the representation store. In an embodiment, eviction is determined based on a timestamp of the representation, a last time a content was detected, added, etc., to the representation, a combination thereof, and the like.

At S330, a check is performed to determine if a second web-based resource matches the generated representation. In an embodiment, a second web-based resource includes a plurality of content elements. In some embodiments, the web-based resources are mapped into a vector feature space, such that a vector is generated, for example in a vector database, for each web-based resource, based on at least a content element of the web-based resource.

In an embodiment, two web-based resources are considered similar in response to determining that a vector distance between two vectors, representing each a web-based resource, is below a threshold. In some embodiments, a semantic distance is determined between the two web-based resources, for example by determining a semantic distance between textual contents of each web-based resource.

In certain embodiments, a Levenstein distance is determined between the two web-based resources, between representations of the web-based resources, etc., to determine similarity. In an embodiment, a generative artificial intelligence (AI) model is utilized to determine similarity between web-based resources, between content elements of the web-based resources, etc.

In an embodiment, a neural network, such as convolutional neural network (CNN), is utilized in determining similarity between content elements of web-based resources, for example in determining similarity between two content pictures.

In certain embodiments, web-based resources are determined to be similar by applying a probability, a fuzzy logic rule detection, a combination thereof, and the like. In an embodiment, similarity is performed using a combination of methods, techniques, etc., discussed in more detail herein.

In some embodiments, a web-based resource is determined to be the same based on content, a portion of content, etc. For example, in an embodiment, a content provided by www.example.com/home/ and a content provided at www.example.com/index/ and a content provided at home. example. com are all determined to be the same content.

In an embodiment, where the second web-based resource is determined to be similar to the first web-based resource, execution continues at S350. In some embodiments, where the second web-based resource is determined to be unsimilar to the first web-based resource, execution continues at S340.

At S340, a representation is generated of the second web-based resource. In an embodiment, the representation is generated based on a schema which is utilized in generating the representation of the first web-based resource. In certain embodiments, representations are periodically compared to each other to determine similarity, for example in response to changing a rule based on which similarity is determined.

For example, in an embodiment, where a first representation and a second representation are determined to be similar, data from the second representation is imported, merged, etc., into the first representation and stored thereon.

At S350, the second web-based resource is associated with the first representation. In an embodiment, associating a second web-based resource with the first representation includes detecting content elements of the second-web based resource and associating such content elements, metadata of content elements, and the like, with the first representation.

In an embodiment, the representation is deduplicated, such that only unique content elements from each web-based resource is stored in the representation. In some embodiments, storing a content includes storing a representation of the content, such as a hash, checksum, vector, and the like, in place of the actual content.

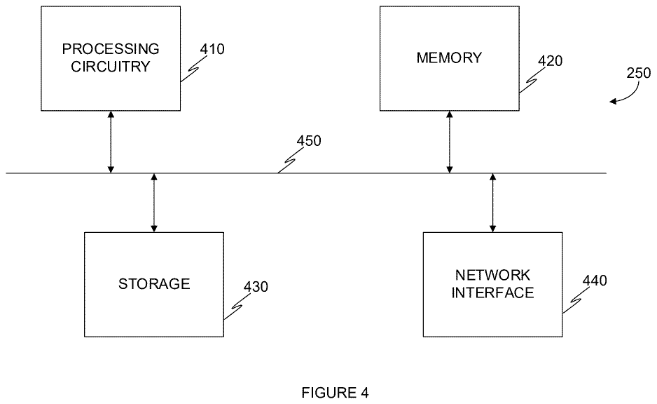

FIG. 4 is an example schematic diagram of a resolution server 250 according to an embodiment. The resolution server 250 includes, according to an embodiment, a processing circuitry 410 coupled to a memory 420, a storage 430, and a network interface 440. In an embodiment, the components of the resolution server 250 are communicatively connected via a bus 450.

In certain embodiments, the processing circuitry 410 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 420 is a volatile memory (e.g., random access memory, etc.), a non-volatile memory (e.g., read only memory, flash memory, etc.), a combination thereof, and the like. In some embodiments, the memory 420 is an on-chip memory, an off-chip memory, a combination thereof, and the like. In certain embodiments, the memory 420 is a scratch-pad memory for the processing circuitry 410.

In one configuration, software for implementing one or more embodiments disclosed herein is stored in the storage 430, in the memory 420, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 410, cause the processing circuitry 410 to perform the various processes described herein, in accordance with an embodiment.

In some embodiments, the storage 430 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 440 is configured to provide the resolution server 250 with communication with, for example, the network 240, the web server 210, and the like, according to an embodiment.

It should be understood that the embodiments described herein are not limited to the specific architecture illustrated in FIG. 4, and other architectures may be equally used without departing from the scope of the disclosed embodiments.

Furthermore, in certain embodiments the external attack surface detector 110, the resolution server 250, the web server 210, a combination thereof, and the like, may be implemented with the architecture illustrated in FIG. 4. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for generating a compact digital representation of a web content, comprising:
detecting a first web-based resource, including a first plurality of content components;
detecting a second web-based resource, including a second plurality of content components;
generating a representation of the first-web based resource;
associating the second web-based resource with the representation of the first web-based resource in response to detecting a match between at least a content of the first plurality of content components and at least a content of the second plurality of content components; and
generating a representation of the second web-based resource, in response to detecting no match between the first plurality of content components and the second plurality of content components.

2. The method of claim 1, further comprising:
detecting that the first web-based resource and the second web-based resource share any one of: a domain, a sub-domain, an IP address, and a combination thereof.

3. The method of claim 1, further comprising:
discovering a plurality of workloads through a public network;
associating a portion of the workloads of the plurality of workloads with an organization; and
detecting the first web-based resource and the second web-based resource on any workload of the portion of the workloads.

4. The method of claim 1, further comprising:
applying a detection rule to detect the match, wherein the detection rule includes a fuzzy logic condition.

5. The method of claim 1, further comprising:
determining a probability value that the first web-based resource is similar to the second web-based resource; and
associating the representation of the second web-based resource with the representation of the first web-based resource in response to determining that the probability value exceeds a threshold.

6. The method of claim 5, further comprising:
generating the representation of the second-web based resource in response to determining that the probability value is below the threshold.

7. The method of claim 1, further comprising:
configuring a generative artificial intelligence (AI) model to detect a match between a first content component of the first plurality of content components and a second content component of the second plurality of content components.

8. The method of claim 7, wherein the generative AI includes any one of: a language model, a generative transformer model, a generative adversarial model, a convolutional neural network, and any combination thereof.

9. The method of claim 1, further comprising:
updating a representation with associated web-based resources, in response to determining that a content component of an associated web-based resource has changed.

10. A non-transitory computer-readable medium storing a set of instructions for generating a compact digital representation of a web content, the set of instructions comprising:
one or more instructions that, when executed by one or more processors of a device, cause the device to:
detect a first web-based resource, including a first plurality of content components;
detect a second web-based resource, including a second plurality of content components;
generate a representation of the first-web based resource;
associate the second web-based resource with the representation of the first web-based resource in response to detecting a match between at least a content of the first plurality of content components and at least a content of the second plurality of content components; and
generate a representation of the second web-based resource, in response to detecting no match between the first plurality of content components and the second plurality of content components.

11. A system for generating a compact digital representation of a web content comprising:
one or more processors configured to:
detect a first web-based resource, including a first plurality of content components;
detect a second web-based resource, including a second plurality of content components;
generate a representation of the first-web based resource;
associate the second web-based resource with the representation of the first web-based resource in response to detecting a match between at least a content of the first plurality of content components and at least a content of the second plurality of content components; and
generate a representation of the second web-based resource, in response to detecting no match between the first plurality of content components and the second plurality of content components.

12. The system of claim 11, wherein the one or more processors are further configured to:
detect that the first web-based resource and the second web-based resource share any one of:
a domain, a sub-domain, an IP address, and a combination thereof.

13. The system of claim 11, wherein the one or more processors are further configured to:
discover a plurality of workloads through a public network;
associate a portion of the workloads of the plurality of workloads with an organization; and
detect the first web-based resource and the second web-based resource on any workload of the portion of the workloads.

14. The system of claim 11, wherein the one or more processors are further configured to:
apply a detection rule to detect the match, wherein the detection rule includes a fuzzy logic condition.

15. The system of claim 11, wherein the one or more processors are further configured to:
determine a probability value that the first web-based resource is similar to the second web-based resource; and
associate the representation of the second web-based resource with the representation of the first web-based resource in response to determining that the probability value exceeds a threshold.

16. The system of claim 15, wherein the one or more processors are further configured to:
generate the representation of the second-web based resource in response to determining that the probability value is below the threshold.

17. The system of claim 11, wherein the one or more processors are further configured to:
configure a generative artificial intelligence (AI) model to detect a match between a first content component of the first plurality of content components and a second content component of the second plurality of content components.

18. The system of claim 17, wherein the generative AI includes any one of:
a language model, a generative transformer model, a generative adversarial model, a convolutional neural network, and any combination thereof.

19. The system of claim 11, wherein the one or more processors are further configured to:
update a representation with associated web-based resources, in response to determining that a content component of an associated web-based resource has changed.
